(19) United States
(12) Patent Application Publication
(10) Pub. No.: US 2016/0364748 A1
(43) Pub. Date: Dec. 15, 2016

(54) COMPUTER-IMPLEMENTED METHOD AND SYSTEM FOR ASSIGNING YIELD AND REVENUE VALUES TO WEB PAGE CONTENT IN REAL TIME

(71) Applicant: Outbrain Inc., New York, NY (US)

(72) Inventors: Nicholas Paul, Los Angeles, CA (US); Cham Kim, Fullerton, CA (US); Danny Wong, Van Nuys, CA (US)

(21) Appl. No.: 14/737,280

(22) Filed: Jun. 11, 2015

(51) Int. Cl. G06Q 30/02

(52) U.S. Cl. CPC G06Q 30/0246; G06Q 30/0247; G06Q 30/0277

(57) ABSTRACT

A computer-implemented method and system for assigning yield and revenue values to web page content in real time. The method and system may comprise the steps of: providing a script component and an application server; prompting a user to embed the script component into a web page; analyzing the ad metadata of the web page; sending, based at least in part on the ad metadata and the visitor metadata, the event to the application server; analyzing the event; determining, based at least in part on the event, the one or more ads that would be displayed on the web page; and determining a revenue data based on the one or more ads. Each event may comprise: an ad name data, ad size data, ad keyword data, and an ad traffic source data. The visitor metadata may comprise: a location of the user, a device type of the user.

### FIELD OF USE

The present disclosure relates generally to improved methods for analyzing and valuating web content, and more particularly, to computer-implemented methods for assigning yield and revenue figures to individual web page contents such as ads in real-time.

### BACKGROUND

In recent years, website publishers have desired to collect data and information relating to their content of their web sites such as yield and total page revenue. For example, publishers may gather information relating to how a visitor navigates through their website (i.e., web analytics data) and use such information to develop web usage statistics to express the amount of money that their website may earn each time a visitor arrives or clicks through to a new web page (i.e., monetization). This information may also be used to identify areas of their websites that are in need of redesign or targeted advertising.

Web analytics data is usually obtained by analyzing log files or page tagging and is often gathered and stored at a provider's database. This data may be processed and later used to generate various web-analytics reports that may be utilized by a website administrator to assess and optimize their website. Such data, for example, may be used to identify the amount of visitors that are visiting a particular web page and possibly the amount of visitors making purchases on that website.

Unfortunately, most web publishers generally do not know the monetary value of each piece of content in their website. Web publishers, for instance, lack the tools and understanding as to how to valuate and assess their web content. Most web publishers also generally do not understand the true return of investment (ROI) of their website, the ability to recognize page layout value, and how to maximize revenue with their websites. As a result, most publishers generally lack the knowledge as to what and which web content they should distribute or market and also when and where to surface such content. This may cause publishers to depend their yield strategy solely on using content engagement metrics, which is generally inaccurate and unreliable.

Therefore, what is needed is a new and improved computer-implemented method and system for assigning yield and revenue values to web page content. This will preferably allow publishers to improve content strategy, help maximize revenue, and understand the revenue per mille (RPM) or return of investment of the user's website content. Mille is French for a thousand, so RPM means revenue per 1000 page views. Preferably, the computer-implemented method will allow the publishers to assign such yield/revenue values in real-time.

### SUMMARY OF EMBODIMENTS

To minimize the limitations in the prior art, and to minimize other limitations that will become apparent upon reading and understanding the present specification, the present invention discloses a new and useful computer-implemented method for assigning yield and revenue values to web page content in real time.

One embodiment may be a computer-implemented method for assigning yield and revenue values to web page content in real time, the steps comprising: providing a script component and an application server; wherein the script component is configured to run on one or more web pages of a computer system and is configured to analyze an ad metadata associated with one or more ads of the one or more web pages when the script component is running; wherein the application server is configured to: analyze one or more events; determine the one or more ads based on the one or more events; and determine a revenue data based on the one or more ads; prompting a user to embed the script component into the one or more web pages; analyzing the ad metadata when the script component is running; sending, based at least in part on the ad metadata, the one or more events to the application server; analyzing the one or more events of the one or more web pages; determining, based at least in part on the one or more events, the one or more ads that would be displayed on the one or more web pages; and determining a revenue data based on the one or more ads. The one or more events may comprise an ad name data. The one or more events may comprise an ad size data. The one or more events may comprise an ad keyword data. The one or more events may comprise an ad traffic source data. The computer-implemented method may further comprise the step of: filtering one or more ad line items associated with the one or more web pages. The computer-implemented method may further comprise the step of: assigning one or more revenue values to one or more web pages based on the revenue data.

Another embodiment may be a computer-implemented method for assigning yield and revenue values to web page content in real time, the steps comprising: providing a script component and an application server; wherein the script component is configured to run on one or more web pages of a computer system and is configured to analyze an ad metadata associated with one or more ads of the one or more web pages and a visitor metadata when the script component is running; wherein the application server is configured to: analyze one or more events; determine the one or more ads based on the one or more events; and determine a revenue data based on the one or more ads; prompting a user to embed the script component into the one or more web pages; analyzing the ad metadata and the visitor metadata when the script component is running; sending, based at least in part on the ad metadata and the visitor metadata, the one or more events to the application server; analyzing the one or more events of the one or more web pages; determining, based at least in part on the one or more events, the one or more ads that would be displayed on the one or more web pages; and determining a revenue data based on the one or more ads. The one or more events may comprise an ad name data. The one or more events may comprise an ad size data. The one or more events may comprise an ad keyword data. The one or more events may comprise an ad traffic source data. The visitor metadata may comprise a location of the visitor. The visitor metadata may comprise a device type of the visitor. The computer-implemented method may further comprise the step of: filtering one or more ad line items associated with the one or more web pages. The computer-implemented method may further comprise the step of: assigning one or more revenue values to one or more web pages based on the revenue data.

Another embodiment may be a system for assigning yield and revenue values to web page content in real time, comprising: one or more non-transitory computer readable storage mediums; a script component, the script component stored in the one or more non-transitory computer-readable storage mediums; and an application server, the application server stored in the one or more non-transitory computer-readable storage mediums; wherein the script component is configured to run on one or more web pages of a computer system and is configured to: analyze an ad metadata associated with one or more ads of the one or more web pages and a visitor metadata when the script component is running; and send, based at least in part on the ad metadata and the visitor metadata, one or more events to the application server; wherein the application server is configured to: analyze one or more events; determine the one or more ads based on the one or more events; and determine a revenue data based on the one or more ads; and assign one or more revenue values to one or more web pages based on the revenue data. The one or more events may comprise an ad name data, an ad size data, and an ad keyword data. The one or more events may comprise an ad traffic source data. The visitor metadata may comprise a location of the visitor and a device type of the visitor.

It is an object to provide a computer-implemented method and system that assigns yield and revenue figures to individual page contents in real-time. Preferably, the method and system provides a calculation via an algorithm that takes into consideration various factors, including (1) the location of individual(s) or visitors who visit the publisher's websites, (2) the type of devices that the pages were viewed on; (3) the ad placements; and (4) the keywords associated therewith that have a direct impact on what kind of advertisement would be displayed (i.e., ad targeting).

It is an object to provide a computer-implemented method and system that preferably divides the total actual revenue earned among all web page contents in real time and accurately. Preferably, the method and system involves an application server that tracks the individual revenue as to how much each ad campaign or line item makes for the website(s) belonging to a particular publisher, and may preferably assign the revenue of the ad campaigns on the webpages appropriately.

It is an object to provide a computer-implemented method and system that: (1) identifies the traffic source (e.g., internal vs external); (2) identifies keywords associated with the ads when dividing content revenue and associate revenue values to various external referral websites (e.g. Facebook®, Google®, Twitter®); and (3) identifies keywords used for ad targeting.

It is an object to provide a computer-implemented method and system that provides users/publishers with: (1) holistic yield/revenue via revenue per thousand (RPM) relating to individual pieces of web content (i.e., unique uniform resource locators) that are published and engaged; (2) the type of device in which the web content is being accessed from (e.g., desktop computer, tablet, mobile); and (3) the type of engagement is coming from (e.g., social media, search engine, internal advertisements).

It is an object to provide a computer-implemented method and system that calculates the yield/revenue in real-time, thereby allowing users or publishers to provide web pages that operate more efficiently.

It is an object to provide a computer-implemented method and system that calculates the yield/revenue in relation to content consumption (i.e., page firing events).

It is an object of the new method and system to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a flow chart of one embodiment of the computer-implemented method for assigning yield and revenue values to web page content in real time.

FIG. 2 is a block diagram of one embodiment of a computer system.

FIG. 3 is a flow diagram of one embodiment of the step of prompting a publisher to embed the script component into a web page.

FIG. 4 is a flow diagram of one embodiment of the step of analyzing an ad metadata and a visitor metadata when the script component is running.

FIG. 5 is a flow diagram of one embodiment of the step of analyzing the event of the one or more web pages.

FIG. 6 is a flow diagram of one embodiment of the step of assigning one or more revenue values to one or more web page contents based on the revenue data.

FIG. 7 is an illustration of various embodiments of line items used for the RPM calculation.

FIG. 8 is an illustration of one embodiment of a portion of web page metadata.

FIG. 9 is an illustration of one embodiment of an ad metadata.

FIG. 10A is a screenshot of one embodiment of a web page based on the page metadata and ad metadata shown in FIGS. 7 and 8, respectively.

FIG. 10B is a screenshot of one embodiment of a web page shown in FIG. 9A and shows how the console provides data or information relating to the web page and ad, including a revenue value.

### DETAILED DESCRIPTION OF ILLUSTRATIVE EMBODIMENTS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the graphs, figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For example, the terms “computer”, “computer system”, “server”, “ad server”, and “application server” generally refer to any device that processes information with an integrated circuit chip, including without limitation, mainframe computers, work stations, gaming consoles, servers, desktop computers, portable computers, laptop computers, and embedded computers. Furthermore, the term “mobile computing device” may refer to any wireless devices including cellular phones, tablet computers, personal digital assistants, digital media players, portable game players, and hand-held computers. The term “ad server” may refer to a computer server or web server that stores advertisements used in online marketing and delivers them to website visitors. The ad server may utilize various ad software such as DoubleClick® for Publishers (DFP), Atlas AdManager®, and Open AdStream®.

As used herein, the term “Internet” generally refers to any collection of networks that utilizes standard protocols, whether Ethernet, Token ring, Wi-Fi, asynchronous transfer mode (ATM), Fiber Distributed Data Interface (FDDI), code division multiple access (CDMA), global systems for mobile communications (GSM), long term evolution (LTE), or any combination thereof.

As used herein, the term “computer-readable medium” may refer to any storage medium configured to store data and/or instructions that are executable by a processor or a computer system. The computer-readable storage medium may be a computer-readable non-transitory storage medium and/or any non-transitory data storage circuitry (e.g., buffers, cache, queues) within transceivers of transitory signals. The computer-readable storage medium may also be any tangible computer readable medium. In various embodiments, a computer readable storage medium may also be able to store data which is able to be accessed by the processor of the computer system. Examples of such computer-readable mediums may comprise, without limitation: a floppy disk, magnetic hard disk drive, a solid state hard disk, flash memory, USB thumb drive, random access memory (RAM), read only memory (ROM), an optical disk, magneto-optical disk, and the register file of the processor. Examples of optical disks may include Compact Disks (CD) and Digital Versatile Disks (DVD), for example: CD-ROM, CD-RW, CD-R, DVD-ROM, DVD-RW, or DVD-R disks. The term “computer readable storage medium” may also refer to various types of recording media capable of being accessed by the computer device via a network or communication link. For example data may be retrieved over a modem, over the internet, or over a local area network.

As used herein, the terms “script”, “script component”, “engine”, “application”, “application server”, “software”, or “software application” may refer to any set of machine-readable instructions on a client machine, web interface, and/or computer system, that directs a computer's processor to perform specific steps, processes, or operations disclosed herein.

As used herein, the term “interface device” generally refers to any device used to input data and commands into a computer system and may include, without limitation, displays, keyboards, touchscreens, speakers, microphones, mice, track balls, touchpads, printers, and the like.

As used herein, the terms “prompt” or “prompting” may refer to any act to assist or encourage a user or perform a certain act. The terms “prompt” or “prompting” may also refer to any passive action or inaction or may refer to permitting a user to perform a certain act without the assistance or act of the software application.

As used herein, the term “publisher” may refer to any web page content owner who enables and/or authorizes one or more third-party content providers to serve content that is displayed in the content owner's web page.

The present specification discloses a computer-implemented method and system for assigning yield and revenue values to web page content in real time. A visitor may request web content on a device and that content may then be loaded for viewing. Upon loading of the web page, various data and codes are loaded within the metadata of the web page, each of which preferably provide different revenue values (yield). A script component (e.g., Javascript®) is preferably integrated within the web page and preferably identifies these data or codes (relating to display ads, video ads, native ads, third party). After the codes are identified, the targeting parameters of the ad server are then generally tied to the URL. An application server preferably matches these targeting parameters to all line items that match the targeting criteria, and based on the settings within the ad server, the application server may then calculate: the amount of revenue generated on the web page; and potential winning line items for future views of the URL. After choosing the winning line items, the application server preferably calculates the total RPM per code on the web page with various third party revenue platforms on the web page to deliver back page level RPM against each content page loaded. Preferably, the data is delivered in real-time and accurate revenue values are preferably determined per web content. The data is then preferably displayed within a computer system for users or publishers to view.

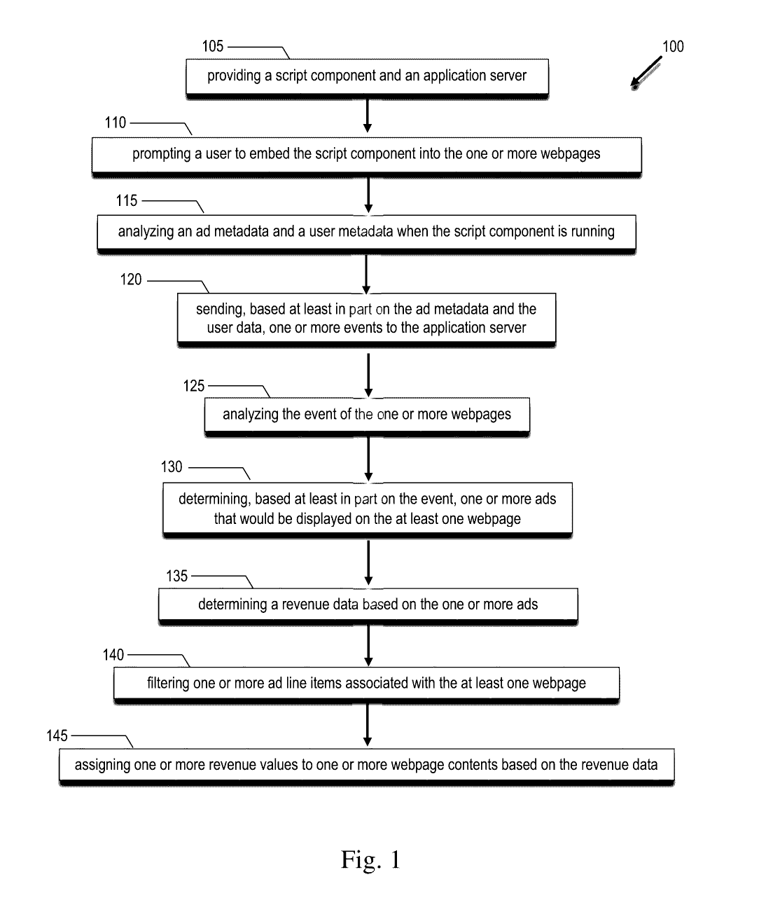

FIG. 1 is a flow chart of one embodiment of the computer-implemented method for assigning yield and revenue values to web page content in real time. As shown in FIG. 1, one embodiment of the method 100 may comprise the steps: 105, 110, 115, 120, 125, 130, 135, 140, and 145. In the first step 105, the user of the method 100 may first provide and utilize a script component and an application server. The script component or computer script is generally a list of commands that are executed by a particular application or program such as a web browser and may be used to automate processes to generate web pages on a computer system. The script component may be hardcoded onto the publisher's web page(s) and is preferably configured to capture ad server code or metadata of the web page. The script component also preferably communicates with the application server to provide event data for measuring content page yield. For example, in one embodiment, the script component may be Javascript® commands that are configured to be embedded as part of web browsers for interacting with the application server. The script component may also be a publisher-side script that may locate and seek metadata of various advertisements displayed on the webpage.

The application server may be a software application or server device that provides data relating to the monetary value of content in a webpage. The application server may be a single computer system or software application or may comprise multiple computer systems or software modules. Preferably, the ad server provides a holistic page yield measured in revenue per thousand page views (RPM) and the total generated revenue associated to each piece of content. The application server is also preferably configured to add the total line items and delivers the total amount of yield or potential revenue to the publisher. In a preferred embodiment, the application server preferably runs on a computer system such as a server and may interact with one or more ad servers via application programming interface software (API) and/or ad software such as DoubleClick® for Publishers (DFP).

Turning to step 110, the user or publisher may be prompted to integrate or embed the script component into the web pages that he or she intends to publish. Integrating or embedding the script component may be accomplished in various ways such as installing an external file or executable file, hard coding (e.g., placing scripts in the <body> and the <head> sections of a hypertext markup language (HTML) page), specifying a value of an HTML attribute in an event handler, or through the body of a URL that utilizes a special script protocol. For example, the script component may be embedded into the web documents between a pair of script tags (i.e., between <script> and </script> tags) or may be embedded via a Javascript® protocol. In one embodiment, embedding of the script component may be integrated, for example, as single line of script onto the publisher website that the user or publisher wishes to have include. The script component may be added to a website by the publisher in, for example, a one-time set up and may be further configured remotely.

Once embedded in the web pages and running, the script component may analyze the metadata of the web pages, as shown in step 115. Specifically, in a general operation, the browser of the visitor's machine may transmit a request for information, which generally includes web content and metadata. Metadata generally refers to data or rules that are created for the display of ad content in a web page. The script component may search for information relating to the ads directed to the webpage and may also be configured to search for data regarding the visitor(s) of that web page. For example, in one embodiment, the script component may analyze the ad metadata on the web page and preferably obtain ad metadata values such as the file name of the ad (i.e., ad name data), data and/or time of the ad, size of the ad (i.e., ad size data), a height of the ad, a width of the ad, and associated keywords of the ad (i.e., ad keyword data). Thus, the ad name data, ad size data, and ad keyword data are preferably associated with the ads in relation to the ad targeting aspects of the web page(s).

In an additional embodiment, the script component may also detect visitor metadata or web page metadata. Specifically, the script component may analyze the metadata to determine the source of the ad traffic (i.e., ad traffic source data), which may either be an internal circulation of the ad within the same publisher, website, or an external source such as a visitor click from another website (e.g., facebook.com, google.com). The script component may also analyze and determine the type of device that the web page is accessed on (i.e., device type of the visitor), which may include personal computers, laptops, smartphones, tablets, and the like. Further, the script component may also obtain the location of the visitor (i.e., location of the visitor), which may indicate a country, state, and city. Examples of some locations may include, without limitation, United States, Canada, or Mexico.

FIG. 1 also shows steps 120 and 125. In these steps, once the script component preferably acquires such information from the ad metadata and visitor metadata, the script component may send or transmit one or more event(s) to the application server. The event(s) are generally any data that is generated responsive to and/or indicates the completion or occurrence of a particular activity or action. Each event may pertain to a particular web page and preferably contains data or information about the ads and visitors of the web pages. For example, an event may comprise ad name data, ad size data and keyword data. The event may also comprise traffic source data, device type data of the visitor, and the location of the visitor. Once the event has been received by the application server, the application server preferably analyzes the event of the web pages.

Referring to step 130, the application server may then determine, based at least in part on the event, ads that would be displayed on the webpages. Specifically, the application server may analyze the event data to determine the information extracted from the metadata of the ads. Examples of such information may include: ad size, ad name, keywords associated with the ad, and the type of the device. Based on this event data, the application server may then identify the ad server's targeting parameters, which are generally included in the URL. The application server may then match the ad server targeting parameters to various items that match the ad server's targeting criteria.

Turning to step 135, the application server may then determine a revenue data based on the ads. Specifically, based on the settings within an ad server such as priorities, impressions, and amount of clicks, the application server may then calculate: (1) the amount of revenue generated on each web page and (2) the favorable line items for future views of the URL. Preferably, the successful line items are chosen, and the ad server may then calculate the total RPM per ad, web page. This may be accomplished by interaction with other third party revenue platforms to deliver back page level RPM against each content page loaded.

The method 100 may also comprise step 140, which is to filter ad line items associated with the webpages. In an embodiment, the application server may filter or exclude ad line items, which are generally a group of advertisements that are often associated with targeting criteria that may identify one or more characteristics of visitors (e.g., gender, age, interest, demographic trait). In the event when the desired data traffic has been met, the application server may then filter out certain ad line items, especially those lacking fixed views or click goals. The application server may also filter those ad line items that are not in flight nor in delivery. This will likely help allow the application server to derive the most accurate revenue potential.

FIG. 1 also shows step 145. Here, after the application server preferably analyzes the events and calculates the total revenue or yield of each web page, the application server 350 may calculate and assign the revenue values to the web page contents of the user's or publisher's website. Because each web page may comprise one or more ads and corresponding ad slots for each ad, the application server may then provide a calculation of revenue figures for each ad. Preferably, the revenue values are calculated in real time, and are preferably directed to each ad slot. Preferably, the revenue values are calculated in real time and are preferably directed to each hardcoded partner (e.g., Outbrain, Taboola, etc. . . . ). The user or publisher may then access the revenue data through a console remotely. Other values that the application server may provide may be event data and/or user data.

Although FIG. 1 shows nine steps, it should be understood that the method 100 may comprise any number of steps and the steps may be performed in alternative orders. Additionally, the method 100 may lack one or more or any of the steps shown in FIG. 1.

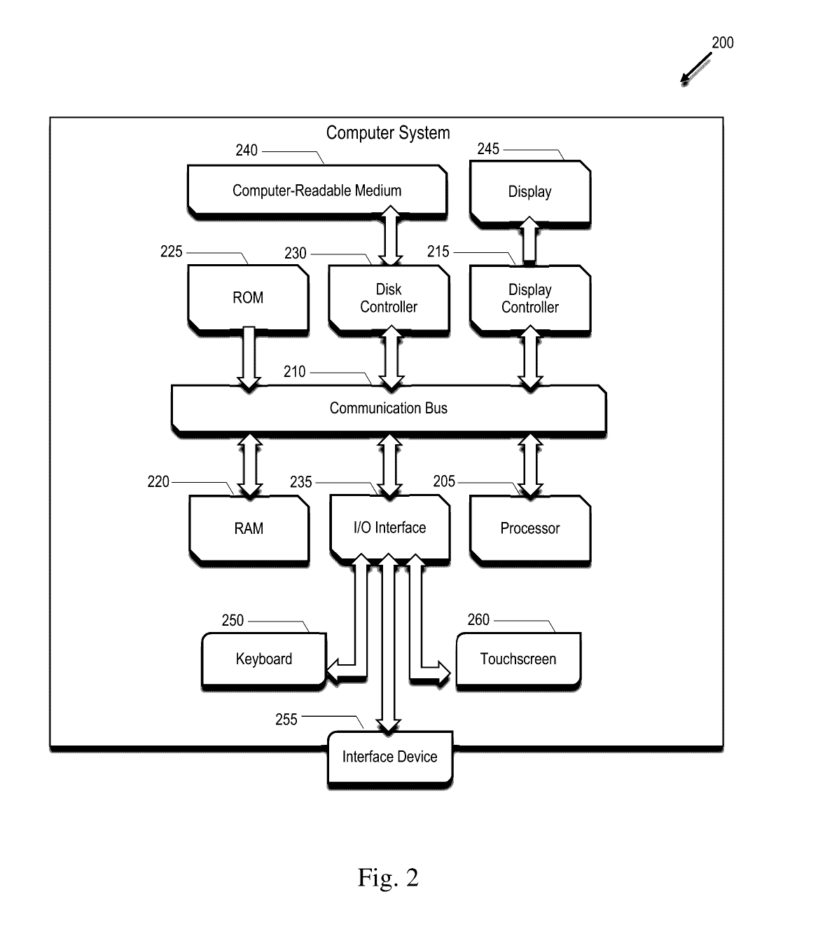

FIG. 2 is a block diagram of one embodiment of a computer system. As shown in FIG. 2, one embodiment of the computer system 200 may comprise: a processor 205, communication bus 210, display controller 215, random access memory (RAM), 220, read only memory (ROM) 225, disk controller 230, input/output interface (I/O interface) 235, computer-readable medium 240, display 245, and one or more interface devices 255; wherein the one or more interface devices 255 may be: a keyboard 250, pointing device (e.g., mouse), and/or a touchscreen 260. In one embodiment, the computer system 200 may be a desktop computer. In another embodiment, the computer system 200 may be server. In various embodiments, the computer system 200 may be a smartphone, laptop, tablet computer, and the like. The computer system 200 may comprise the processor 205 connected through a communication bus 210, wherein the communication bus 210 may further connect to other electronic hardware, including without limitation, a display controller 215, RAM 220, ROM 225, disk controller 230, and I/O interface 235. The disk controller 230 may be configured to control the computer-readable medium 240, which may be a hard drive and/or optical disk drive. The computer-readable medium 240 may also be another form of random access memory or flash memory. The display controller 215 may be connected to a display 245 such as a liquid crystal display (LCD), projection system, or touchscreen. The I/O interface 235 may be connected to one or more input devices such as an interface device 255 (e.g., mouse, keyboard, pointing device, touchscreen). In additional embodiments, the computer system 200 may also comprise a network controller card connected through a network, such as the Internet or along an Intranet.

The processor 205 may be configured to execute a set of computer readable instructions and further to execute a software program, application, scripts (e.g., Javascript®) or computer implemented instructions described herein. The computer readable instructions and application may comprise instructions that cause the processor 205 to perform one or more processes when the instructions are executed by the processor 205. In other various embodiments, the computer readable instructions or application may be tangibly embodied in the memory of the computer system 200 such as the RAM 220 or ROM 225, as shown in FIG. 2, or on a computer-readable storage medium, such as a magnetic, optical or solid-state digital storage medium.

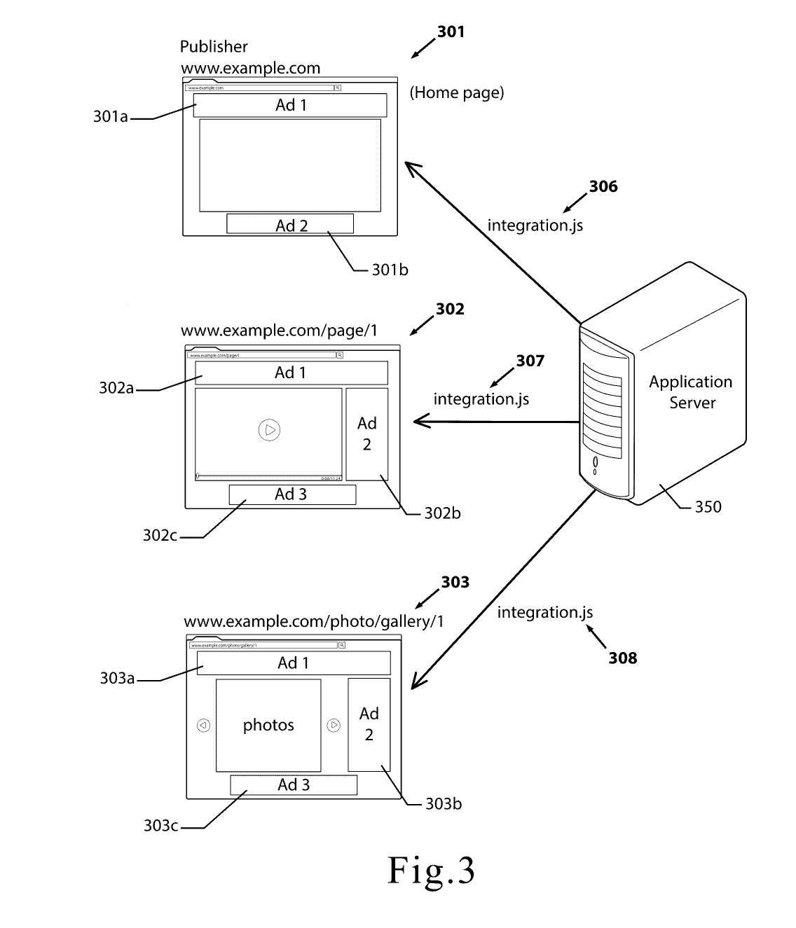

FIG. 3 is a flow diagram of one embodiment of the step of prompting a publisher to embed the script component into a web page. As shown in FIG. 3, one embodiment of step 110 may comprise: an application server 350, web pages 301, 302, 303, and script components 306, 307, 308. FIG. 3 also shows that each of the web pages 301, 302, 303 may comprise advertisements. Specifically, web page 301 may comprise advertisements 301a, 301b; web page 302 may comprise advertisements 302a, 302b, 302c; and web page 303 may comprise advertisements 303a, 303b, 303c.

As discussed above, a user or publisher may integrate the script component in every web page content. Preferably, the script component 306, 307, 308 is a Javascript® component (e.g., a file.js, integrationjs) and may be used to obtain data or information about the ads and visitors via the ad metadata and visitor metadata, respectively. The user or publisher may integrate/embed the script component 306, 307, 308 into the web pages 301, 302, 303 in various ways such as installing an external file or executable file, hard coding, specifying a value of an HTML attribute in an event handler, or through the body of a URL that utilizes a special script protocol. In various embodiments, the script component 306, 307, 308 may be embedded into the web documents between a pair of <script> and </script> tags or via a Javascript® protocol. Preferably, the script component 306, 307, 308 is embedded onto the publisher website that the user or publisher wishes to have include.

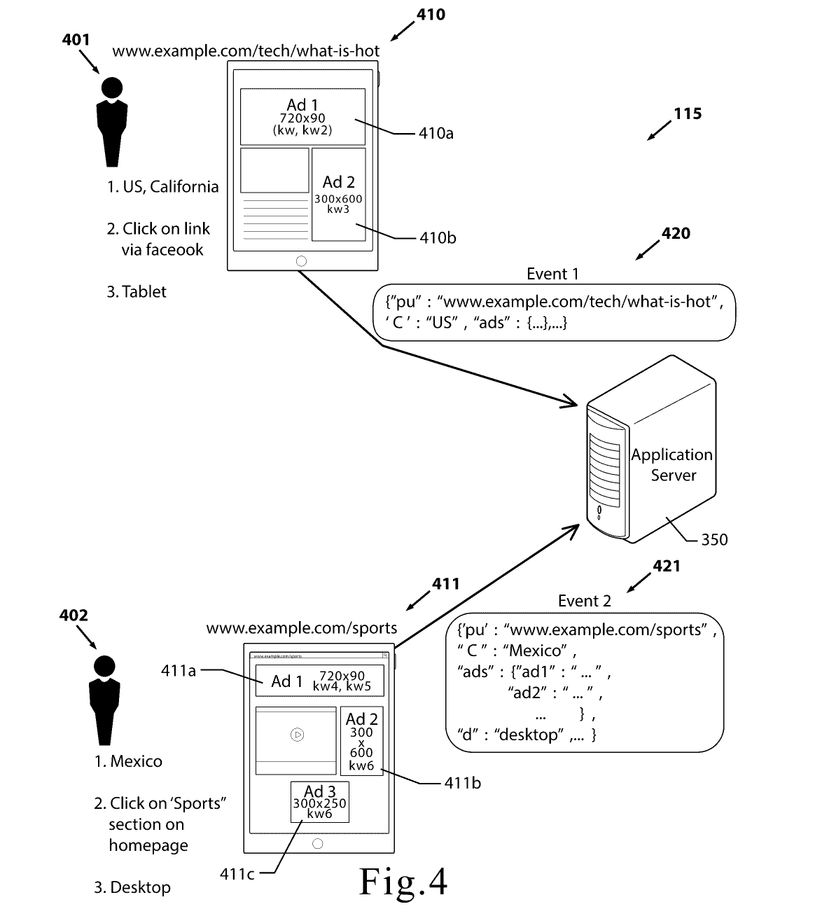

FIG. 4 is a flow diagram of one embodiment of the step of analyzing an ad metadata and a visitor metadata when the script component is running. As shown in FIG. 4, one embodiment of the step 115 (i.e., analyzing an ad metadata and a visitor metadata) may comprise: an application server 350, web pages 410, 411, visitors 401, 402 and events 420, 421. FIG. 4 also shows that each of the web pages 410, 411 may comprise ads. Specifically, web page 410 may comprise ads 410a, 410b, and web page 411 may comprise ads 411a, 411b, 411c.

As discussed above, when a visitor visits a web page 410, 411 of a user's or publisher's website, the script component of the web page 410, 411 may gather and analyze the metadata, video metadata, and ad metadata on the web page 410, 411 and preferably derives the information about the ads 410a, 410b, 411a, 411b, 411c, including the name of the ad 410a, 410b, 411a, 411b, 411c (i.e., ad name data), size of the ad 410a, 410b, 411a, 411b, 411c (i.e., ad size data), and associated keywords of the ad 410a, 410b, 411a, 411b, 411c (i.e., ad keyword data). The ad name data, ad size data, and ad keyword data are preferably associated with the ads 410a, 410b, 411a, 411b, 411c, in relation to the ad targeting aspects of the web page(s). In an additional embodiment, the script component may also analyze the web page metadata, video metadata, and ad metadata to derive certain information. Such information may then be sent to the application server 350 for processing via event(s). For example, some of the information that the script component may analyze on a web page metadata and transmit to the application server may be: an internet protocol (IP) address, uniform resource locator (URL), referrer, location, page category/subcategory, and title, as follows:

IP address: 123.123.123.123

Page url: http://www.example.com

Referrer: http://www.referrer.com

Location: USA

Category: Homepage

Sub Category: Homepage

Title: Examples

Similarly, in one embodiment, the script component may also analyze video metadata to obtain information such as: the type of video player, ad, name, size, and key values, as follows:

Analyze Video metadata:

Video player: Brightcove

Ad: Pre, Post, Mid, overlay

Name: /123456/video

Size: 2×2

Key-Values (custom criteria): kyd=video1, behavior=12345, layout=homepage

In one embodiment, the script component may also analyze ad metadata or ad unit code(s) on a web page to obtain information such as: ad name, size of the ad, and key values, as follows:

Analyze ad unit code(s) on page:

Name: /123456/example_homepage_728×90

Size: 728×90, 970×90, 970×250

Key-Values (custom criteria): kyd=example1, behavior=12345, layout=homepage

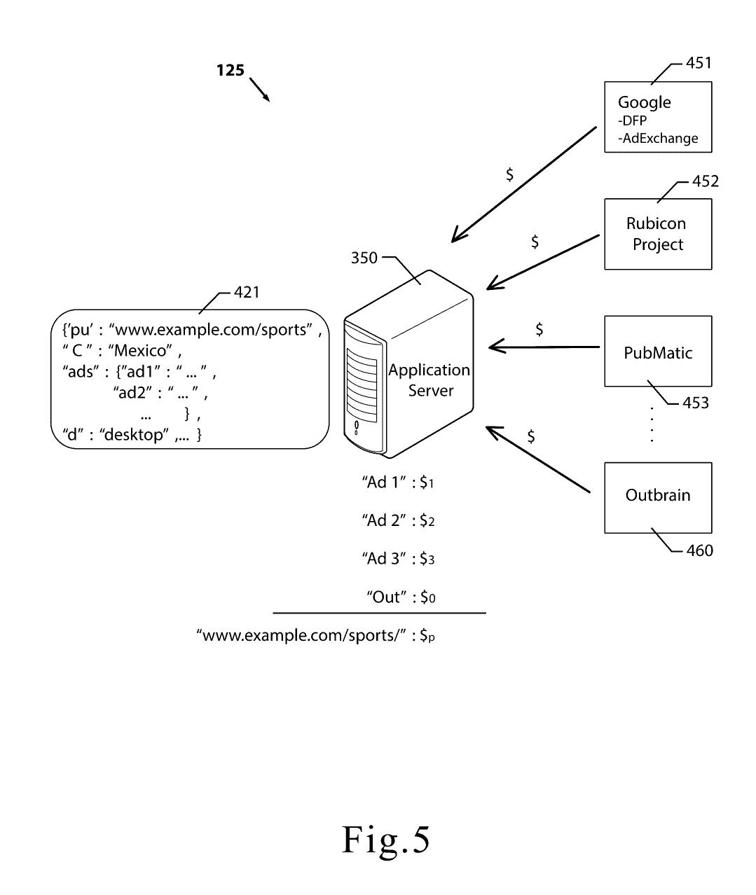

Based, at least in part of some of the information above, the script component may then detect where the source of the page traffic comes from (i.e., ad traffic source data), which may either be an internal circulation of the page or an external source such as a visitor click from another website (e.g., facebook.com, google.com). Still, in another embodiment, the script component may also detect the type of device the web page is accessed or viewed on (i.e., device type of the visitor) and the location of the visitor (i.e., location of the visitor). The location of the visitor may be, for example, from various countries such as the United States, Canada, or Mexico. Once the script component acquires such information from the ad metadata and visitor metadata, the script component preferably sends or transmits the event(s) to the application server 350 in order to provide the information or data (shown in FIG. 5). The location may be more specific, including the State and or city.

FIG. 5 is a flow diagram of one embodiment of the step of analyzing the event of the one or more web pages. As shown in FIG. 5, one embodiment of the step 125 (i.e., analyzing the event of the one or more web pages) may comprise: an application server 350, events 421, and third party advertiser partners. 451, 452, 453, 460.

As discussed above, after the script components preferably sends the event(s) to the application server 350, the application server 350 may then examine the event(s) in order to determine what ads would be displayed within the ad slots of the web page. Importantly, the application server 350 preferably examines various types of ad metadata, including the name of the ad (i.e., ad name data), size of the ad (i.e., ad size data), associated keywords of the ad (i.e., ad keyword data), type of device the web page is accessed or viewed on (i.e., device type of the visitor), and the location of the visitor (i.e., location of the visitor), all of which are preferably provided by the script component via the event(s). Based on the type of ads, the application server 350 may then calculate or derive the total revenue (i.e., revenue data). The total revenue may be calculated in various algorithms, including determining the potential revenue of the ads selected and other revenue sources obtained from third parties (e.g., content recommendation systems such as Outbrain®) or other third party revenue platforms to deliver back page level RPM against each content page loaded.

In an embodiment, the application server 350 may recognize and filter particular ad line items, which are generally units of advertising that is sold by the publisher to the advertiser. Each line item generally specifies the details of the sale, such as site, section, ad size, date(s) to run and costs. For example, the application server may filter ad line items that do not require fixed views or click goals but are configured with traffic targeting (i.e., whether an ad is served based on the amount of traffic the publisher receives). This may occur in situations where the desired traffic has been met in order to derive the most accurate revenue potential of a web page.

In one embodiment, the application server 350 or recommendation server may initiate the DFP API to make particular ad line items eligible to be selected for the RPM calculation. In particular, the application server 350 may perform the following steps: (1) filter all ad line items and reject those ad line items that are neither in flight nor delivering; (2) match each ad line item to an ad unit based on its internal DFP ID with consideration of inheritance; (3) match each ad line item to the placement(s) the ad unit belongs to; (4) match each ad line item to an ad size; (5) optionally match each ad line item to all key-values; (6) optionally match each ad line item to geography; and (7) match each ad line item to device.

Regarding the first step, the application server 350 may filter ad line items and reject those line items that are not in flight nor in delivery. Flight dates and times of each ad line item are generally broken down to increments in minutes and are usually inclusive of start/end time, and the application server 350 may narrow its selection of particular ad line items based on certain dates/time of flight or delivery or whether those ad line items are currently in flight. The application server 350 may also utilize a time zone set by publisher, and the flight dates and times may be filtered to include specific combinations of (1) days of the week (i.e., Monday, Tuesday, Wednesday, Thursday, Friday, Saturday, Sunday) and (2) hours of the day (e.g., 00:00-01:00, 01:01-02:00). Ad line items may be flight but not delivering yet (in ready state); thus, these ad line items are preferably not included in the RPM calculation.

Next, the application server 350 may match an ad line item to ad unit based on its internal ID while considering. The ad units, which are generally a set of ads corresponding to each particular ad code, may be identified in a tree hierarchy in the ad software with a root ID that is assigned to a network/account when the network is created. Each ad unit generally comprises a parent ad unit which typically has its own ID with the exception of the root ID. For example, if an ad unit on a publisher webpage includes the path ‘/travel/asia’, its ID may be ‘100’, which preferably represents the whole path ‘/travel/asia’ with the parent being the root ID (two level hierarchy in the tree). Alternatively, ‘/asia’ may have an ID ‘200’ with the parent being ‘/travel’ that has its own ID ‘201’ and the grandparent being the root ID (i.e., three level hierarchy in the tree). These IDs are preferably and appropriately resolved, internally, and the publisher may also configure an ad line item to target a particular ad unit ID with or without all its descendants included in the targeting rule. The application server 350 may also check all ad line items that are included or excluded from this ad unit and its parents.

The application server 350 may also match ad line items to each ad placement(s) that the ad unit belongs to. Placements are generally a shell of any combination of ad units and are generally used for grouping ad units where an advertiser's ad can be displayed. Placements may also be used to identify ad units that an advertiser might want to target. Common examples may include: a placement for all leaderboards of a website, placement for all of the seasonal ad spaces on your site, or placement for all of the homepages in a network when multiple websites. The application server 350 thus may verify all ad line items that are included or excluded from placement. If the placement includes the ad unit ID, the application server 350 may include or exclude the ad line item(s).

The application server 350 may then match the ad line item to an ad size. Specifically, the application server 350 may verify all ad line items that are included or excluded from (1) ad unit ID and (2) ad size(s). Then, the application server 350 may then include or exclude the ad line items based on (1) ad unit ID and (2) ad size(s).

Next, the application server 350 may optionally match ad line items to all key-values. Specifically, the application server 350 may verify all ad line items that are included or excluded from (1) ad unit name, (2) ad size(s), and (3) key-value(s). Key-values may comprise a Boolean logic operator functionality (e.g., Boolean “and”, “or”) and may be set up as strings with multiple key-values and/or combinations thereof. The application server 350 may then include or exclude the ad line items based on (1) name of the ad unit, (2) ad size(s), and 3) key-value(s).

The application server 350 may then match the ad line item to geography. Specifically, the application server 350 may verify all ad line items that are included or excluded from (1) ad unit name, (2) ad size(s), (3) key-value(s) (custom criteria), (4) placement(s), (5) USER IP (page metadata) location, and (6) geography in the ad line item setup, which is generally targetable by country, state, city (designated marketing area), and zip code. The application server 350 may then include or exclude ad line items that match (1) ad unit name, (2) ad size(s), (3) key-value(s) (custom criteria), (4) placement(s), (5) USER IP (page metadata) location, and (6) geography in the line item setup.

Finally, the application server 350 may match the ad line item to the device. Specifically, the application server 350 may verify ad line items that are included or excluded from (1) ad unit name, (2) ad size(s), (3) key-value(s) (custom criteria), (4) placement(s), (5) USER IP (page metadata) location, (6) geography in line item setup, (7) flight dates and times, and (8) device(s). Such device(s) may include, without limitation: desktop, feature phone, smartphone, and/or tablet. The application server 350 may then include or exclude those ad line items that match (1) ad unit name, (2) ad size(s), (3) key-value(s) (custom criteria), (4) placement(s), (5) USER IP (page metadata) location, (6) geography in line item setup, (7) flight dates and times, and (8) device(s) targeting. Once all eligible line items are selected, the application server 350 may select certain at line items for RPM calculation. The application server 350 may then assign the revenue values to the web page contents thereafter.

In one embodiment, after analyzing the web page metadata, the ad metadata, and the video metadata, the application server 350 preferably selects the ad line items that will serve from a pool of matched line items per ad (display or video). The application server 350 may then add the revenue figures to provide a holistic page RPM. Specifically, the application server 350 may calculate the revenue for the URL/web page as follows: (1) checking the ad sizes in order; (2) cross-checking other databases to determine which third party hardcoded partner is also involved (e.g., Outbrain, Taboola, etc. . . . ); and (3) calculating the total amount of ad unit RPMs, video unit RPMs, and third party hardcoded partner RPMS to create a holistic page RPM for each URL.

In particular, in the first step of checking ad sizes, the application server 350 may review a list of ad sizes in increasing order. For example, in an embodiment, the application server 350 may review the following ad sizes in order, without limitation: 1×1, 1×2, 2×1, 1200×600, 970×90, 970×66, 970×250, 728×90, 619×66, 300×250, 300×600, 300×350, 240×295, 650×250, 366×204, 320×50, 300×50, 300×400, 320×480, 116×50, 640×480, 300×100. When a line item is selected as a match with the highest CPM, the application server 350 may check to determine what other ad sizes are associated with that ad line item, especially because line items may have various ad sizes. Although twelve different ad sizes are shown, any number of ad sizes may be reviewed by the application server 350.

Importantly, the application server 350 may also check the “display creatives” targeting within each line item. Specifically, there are generally two settings that the application server 350 may checks:
(1) Single: the application server 350 will only choose one of the ad sizes in the line item. Thus, if only one ad size is linked to the line item, then the application server 350 will likely use the CPM of that line item for that ad unit size.
(2) As Many As Possible: The application server 350 may choose all ad sizes associated with the ad line item. If multiple ad sizes are linked to the ad line item, then the application server 350 will use the CPM of the ad line item for all the ad sizes. For example, if there is an ad line item with ad sizes 728×90 and a 300×250 and a CPM of $10, the application server 350 will preferably associate a $5 CPM to the 728×90 and $5 CPM to the 300×250.

The application server 350 may then continue to go through the list of ad sizes until all the ad sizes associated with that web page/URL are filled with ad line items and a respective dollar figure. The application server 350 may then calculate the total dollar amount associated to the ad units on the web page.

Regarding the second step, the application server 350 may then check other databases to determine which third party hardcoded partner are included on the web page. This may be accomplished by associating each website within a database with a website name, category list, and subcategory list. All subcategories may be set with partners such as Outbrain® and Taboola® and a specific RPM figure. There may be multiple partners within a single subcategory, and all URLs may be tied to a subcategory, which may be rolled up into a category. The application server 350 may then calculate the total dollar amount associated to the third party partners on the web page.

Finally, the application server 350 may then calculate the total amount of all ad unit RPMs, video unit RPMs, and third party hardcoded partner RPMs to determine the holistic web page RPM for each URL.

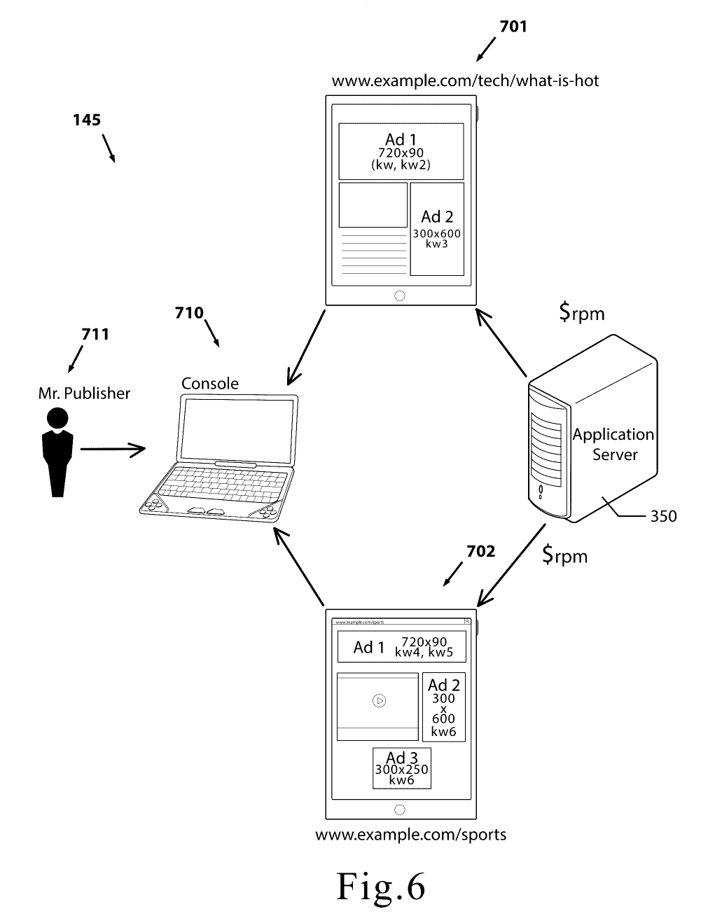

FIG. 6 is a flow diagram of one embodiment of the step of assigning one or more revenue values to one or more web page contents based on the revenue data. As shown in FIG. 6, one embodiment of the step 145 (i.e., assigning one or more revenue values to one or more web page contents based on the revenue data) may comprise: an application server 350, web pages 701, 702, computer system 710, and publisher 711. FIG. 6 shows that after the application server 350 analyzes the events, selects certain ad line items, and determines the total revenue or yield of each web page, the application server 350 may calculate and assign the revenue values to the web page contents of the user's or publisher's website. Preferably, the calculations and assigning of revenue values is performed in real time. In one embodiment, the user or publisher may access the revenue data, event data, and/or user data from the application server 350 via a console shown through another computer system 710.

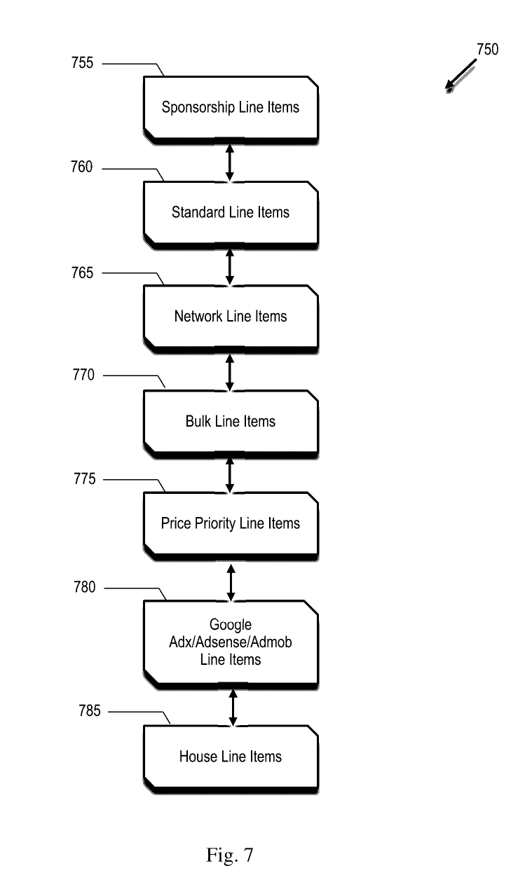

FIG. 7 is an illustration of the various embodiments of line items used for the RPM calculation. As shown in FIG. 7, various embodiments of ad line items may include: sponsorship line items 755, standard line items 760, network line items 765, bulk line items 770, price priority line items 775, Google® Adx/Adsense/Admob line items 780, and house line items 785. After determining which line items are eligible for the RPM calculation, the DFP may select certain line items based on priority—that is, line items may have a one-to-one relationship towards a specific ad type, ranging from highest priority to lowest priority. Thus, in one embodiment, the prioritization of line items may be based on ad types.

In one embodiment, the sponsorship line items 755 may have the highest delivery priority. Sponsorship line items 755 are generally time-based and may be specific to flight dates and times. Sponsorship line items 755 also generally do not have impression or click goals and may deliver more than the impression or click amount set up in the system. In one embodiment, sponsorship line items 755 may always be selected by percentage share of voice (SOV), and the percentage may range from any number(s) from 1 to 100. The total of the percentage(s) of all the sponsorship line items 755 may then sum up to more than 100 (and usually at least one of the sponsorship line item is selected). The application server 350 may use that number as the probability that this particular line item is selected. For example, sponsorship line item 1 may have a 50% SOV and sponsorship line item 2 may have a 30% SOV. Thus, there may be a 50% selected that sponsorship line item 1 will be selected; 30% likelihood that sponsorship line item 2 will be selected; and 20% likelihood that a non-sponsorship line item will be selected. The application server 350 may then generate a random number between 1 and 100 and select a line item based on that value.

Various line items may also be associated with various price types. In one embodiment, three price types may be associated with sponsorship line items: cost per day (CPD), cost per mille-thousand impressions (CPM), and cost per click (CPC). For a CPD, a dollar figure per day may be inputted. However, the application server 350 may need to associate the CPM to the line item. If the sponsorship line item has a lifetime impression cap figure, the application server 350 may then use the figure as-is to calculate the CPM with the following formula:

CPM=(CPD×duration of line item in days)/lifetime impression cap figure/1000).

On the other hand, if the sponsorship line item does not include a lifetime impression cap figure configured in the ad server software, application server 350 may analyze the impression cap inputted within a database to calculate the lifetime impression cap. The database may utilize a y-axis for categories and an x-axis for days of the week (e.g., Monday, Tuesday, Wednesday). The categories are generally manually inputted by application server 350 into the database. The script component may assign specific categories to every URL on the user's or publisher's website. All ad units, ad sizes, and/or ad keywords may then be assigned to the URL and rolled up into this category.

Regarding the days of the weeks, each day may be assigned an impression cap for each specific category. The application server 350 may sum up the impression caps configured for the line item over its lifetime among its target categories to derive the lifetime total impression cap. In addition, the application server 350 may increase or “beef up” the lifetime impression by approximately 5% to accommodate the likelihood that the line item under deliver due to possible discrepancies.

In this embodiment, if the sponsorship line item's delivered impressions has reached the total impression cap (i.e., ad server or database), the CPM may be set at $0 because it may not generate any revenue for the publisher. Otherwise, the application server 350 may calculate the CPM for the line item using the same formula:

CPM=(CPD×duration of line item in days)/(lifetime impression cap figure/1000).

Regarding a CPM, a CPM may be inputted. In one embodiment, if the sponsorship line item's delivered impression has reached the impression cap (i.e., ad server or database), the CPM may be set to $0.

Similarly, regarding a CPC, a CPC may be inputted. The application server 350 may need to calculate the effective CPM (eCPM) for all CPC line items. In this embodiment, it may take the number of clicks for the sponsorship line item multiplied by the CPC=revenue. The application server 350 may then obtain the eCPM with the following equation:

eCPM=Revenue/(Impressions delivered/1000).

Sponsorship line items 755 are generally considered “direct” in the system.

If no sponsorship line item 755 is in the eligible line items list or if a non-sponsorship line item is selected, the application server 350 may then proceed to the next ad type, which may be standard line items 760.

For standard line items 760, in one embodiment, these line items may have the second highest delivery priority. Standard line items 760 may have an agreed upon impression or click amount for specific flight dates and times. Additionally, standard line items 760 may deliver (1) evenly or (2) as fast as possible. If the standard line items 760 are delivered evenly, the number of allocated impressions or clicks may be divided evenly per day across the flight dates and times. On the other hand, if the standard line items 760 are delivered as fast as possible, the number of allocated impressions or clicks may be delivered out as quickly as possible without any daily caps.

Standard line items 760 are generally considered “direct” in the system, and, in one embodiment, two price types may be associated with standard line items 760, which may be CPM and CPC. Both the CPM and CPC may be inputted into the line item, but the application server 350 may also need to calculate a eCPM for all CPC for all CPC line items. In this case, it may take the amount of clicks for the standard line item multiplied by the CPC=revenue. The application server 350 may then obtain the eCPM with the following equation:

eCPM=Revenue/(Impressions delivered/1000).

If multiple standard line items are eligible, the application server 350 may select the line item with the most amount of impressions or clicks necessary for the day or lifetime (depending on “as fast as possible” setting). Additionally, if neither a (1) sponsorship line item 755 nor a (2) standard line item 760 is in the eligible line items list, the application server 350 may proceed to the next ad type, which may be network line items 765.

For network line items 765, in one embodiment, these line items may have the third highest delivery priority. Network line items 765 may have a set of percentage share of voice (SOV), and these percentages may be any value, ranging from 1 to 100. Based on that percentage value, the application server 350 may use an equation to calculate the probability of selecting a specific network line item. For example, if the network line item 765 has 80% SOV, then there may be an 80% likelihood that the network line item is chosen, and a 20% likelihood that a non-network line item will be chosen. The application server 350 may then generate a random value between 1 and 100 and then pick the line item based on that value.

Network line items 765 are generally considered “indirect” in the application server 350, and all indirect price type line items may be overcome by Google® Adx/Adsense/Admob line items, based on dynamic allocation setting. If integrated SSP/Network-like Rubicon is eligible and chosen, the application server 350 may analyze the Rubicon account API and retrieve (1) impressions, (2) winning CPM, and/or (3) revenue associated to the line item.

In one embodiment, three price types may be associated with network line items 765, which may be CPD, CPM, and CPC. For CPD, a dollar figure per day may be inputted. However, the application server 350 may need to associate a CPM to the line item. Additionally, because network line items generally do not have an impression figure, the application server 350 may check the impression cap entered into database. The database may utilize a y-axis for categories and an x-axis for days of the week (e.g., Monday, Tuesday, Wednesday). The categories may be manually inputted by the application server 350 into the database, and the script component may assign specific categories to every URL into the user's or publisher's website. All ad units, ad sizes, and ad keywords may be assigned to the URL and rolled up to the category.

Regarding the days of the weeks, each day may be assigned an impression cap for each specific category. Because network line items 765 generally do not have an impression figure, the application server 350] may review the ad unit matched, the day of the week, and the associated categories to the ad unit. The application server 350 may then calculate the CPM, by the following equation:

CPM=(CPM×duration of line item in days)/(database category & day of the week impression total/1000).

Regarding CPM and CPC, both the CPM and CPC may be inputted. However, regarding the CPC, the application server 350 may need to calculate an eCPM for all CPC line items. In this embodiment, it may take the amount of clicks for the network line item 765 multiplied by the CPC=revenue. Then the application server 350 may determine the eCPM with the following equation:

eCPM=Revenue/(Impressions delivered/1000).

If multiple network line items 765 are eligible, the application server 350 may select the line item with the largest CPM. Additionally, if (1) sponsorship line item 755, (2) standard line items 760, (3) network line items 765, and (4) Google® Adx/Adsense/Admob line items 780 are not in the eligible line items list, the application server 350 may proceed to the next ad type, which may be bulk line items 770.

For bulk line items 770, in one embodiment, these line items may have the fourth highest delivery priority. In this embodiment, bulk line items 770 may have an agreed upon impression or click amount for specific flight dates and times. Additionally, in this embodiment, bulk line items 770 may deliver (1) evenly or (2) as fast as possible. If the bulk items 770 are delivered evenly, the number of allocated impressions or clicks may be divided evenly per day across the flight dates and times. On the other hand, if the bulk items 770 are delivered as fast as possible, the number of allocated impressions or clicks may be delivered out as quickly as possible without any daily caps.

Bulk line items 770 may be considered “indirect” in the application server 350. If integrated SSP/Network-like Rubicon is eligible and chosen, the application server 350 may analyze the Rubicon account API and retrieve (1) impressions, (2) winning CPM, and/or (3) revenue associated to the line item.

In one embodiment, two price types may be associated with bulk line items 770, which may be CPM and CPC. Both the CPM and CPC may be inputted into the line item. However, the application server 350 may need to calculate an eCPM for all CPC line items. In this embodiment, it may take the amount of clicks for the standard line item multiplied by the CPC=revenue. Then the application server 350 may obtain the eCPM with the following equation:

eCPM=Revenue/(impressions delivered/1000).

In this embodiment, if multiple bulk line items 770 are eligible, the application server 350 may select the line item with the most amount of impressions or clicks necessary for the day or lifetime (depending on the “as fast as possible” setting). Finally, if (1) sponsorship line items 755, (2) standard line items 760, (3) network line items 765, (4) bulk line items 770, and (5) Google® Adx/Adsense/Admob line items 780 are not in the eligible line items list, the application server 350 may proceed to the next ad type, which may be a price priority line items 775.

For price priority line items 775, in one embodiment, these line items may have the fifth highest delivery priority. However, price priority line items 775 may have a lifetime impression or click caps serve based on the highest paying line item available. Additionally, price priority line items may be considered “indirect” in the application server 350. In one embodiment, two price types may be associated with priority line items 775, which may be CPM and CPC. Both CPM and CPC may be inputted into the price priority line item 775. However, the application server 350 may need to calculate an eCPM for all CPC line items. In this embodiment, it may take the amount of clicks for the standard line item multiplied by the CPC=revenue. Then the application server 350 may obtain the eCPM with the following equation:

eCPM=Revenue/(Impressions delivered/1000).

If multiple price priority line items 775 are eligible, the application server 350 may select the line item with the highest CPM setting that has not reached its lifetime impression or click goal. If integrated SSP/Network-like Rubicon is eligible and chosen, the application server 350 may analyze the Rubicon account API and retrieve (1) impressions, (2) winning CPM, and/or (3) revenue associated to the line item. Finally, if (1) sponsorship line items 755, (2) standard line items 760, (3) network line items 765, (4) bulk line items 770, (5) price priority line items 775, and (6) Google® Adx/Adsense/Admob line items 780 are not in the eligible line items list, the application server 350 may proceed to the next ad type.

For the Google® Adx/Adsense/Admob line items 780, in one embodiment, these line items may have a dynamic delivery priority based on the administrator settings and the CPM associated to winning CPM's in the Google® Adx/Adsense/Admob account. The Google® Adx/Adsense/Admob line items 780 (i.e., dynamic allocation line items) may compete with any non-dynamic line items (e.g., sponsorship line items 755, standard line items 760, network line items 765, bulk line items 770, price priority line items 775) based on the line item priority and winning CPM from an advertiser. In this embodiment, the Google® Adx/Adsense/Admob line items 780 may be considered “indirect” in the application server 350, and the algorithm on the selection of a Google® Adx/Adsense/Admob line items 780 versus a selected non-dynamic line item may be as follows:
1) An eligible dynamic delivery line item is preferably selected from the pool of the Google® Adx/Adsense/Admob line items 780 by examining the line item type and its priority (note: the eligible line item selected may be used to compete with the previously selected non-dynamic DFP line item based on the CPM).
2) Then: if all the following occurs:
   a. if the line item being examined is a “preferred deal” Adx line item; and
   b. if the priority of this line item is higher (with a lower numeric value) than the regular DFP line item; and
   c. if the CPM on the preferred deal Adx line item is higher than the CPM of the regular DFP line item,
   then the Adx line item is selected rather than the non-dynamic line item.
3) Otherwise, the priority of the Google® Adx/Adsense/Admob line items 780 is examined, as follows:
   a. If the priority of the line item has a value between 1 and 11:
      i. if the non-dynamic DFP line item is the same priority as the Google® Adx/Adsense/Admob line item 780; and the non-dynamic DFP line item has no delivery goal (i.e., price priority line item); or
      ii. if the non-dynamic DFP line item is of a lower priority than the Google® Adx/Adsense/Admob line item 780;
      then the Adx line item is selected rather than the non-dynamic line item.
   b. If the priority of the line item has a value of 12 or higher:
      i. If the priority of the line item is of equal or higher priority than the non-dynamic DFP line item, then the CPM of the Google® Adx/Adsense/Admob line item is compared with the non-dynamic DFP line item.
      ii. If the CPM of the Google® Adx/Adsense/Admob line item has a higher CPM, then the Google® Adx/Adsense/Admob line item will preferably be selected.

If a (1) sponsorship line item 755, (2) standard line item 760, (3) network line item 765, (4) bulk line item 770, (5) price priority 775, and (6) Google® Adx/Adsense/Admob line item 780 are not in the eligible line items list, the application server 350 may proceed to the last line item type, which may be house line items 785.

In one embodiment, house line items 785 may have the lowest delivery priority. House line items 785 generally have not impression or click caps and may only serve when no other line item is available. House line items 785 may also be considered “house” in the system, and generally will always serve if no other line items are eligible.

After analyzing the page metadata, the ad metadata, the video metadata, and selection of line items that will serve from a pool of matched line items per ad (i.e., display or video), the application server 350 will preferably add the revenue figures to provide a holistic page RPM.

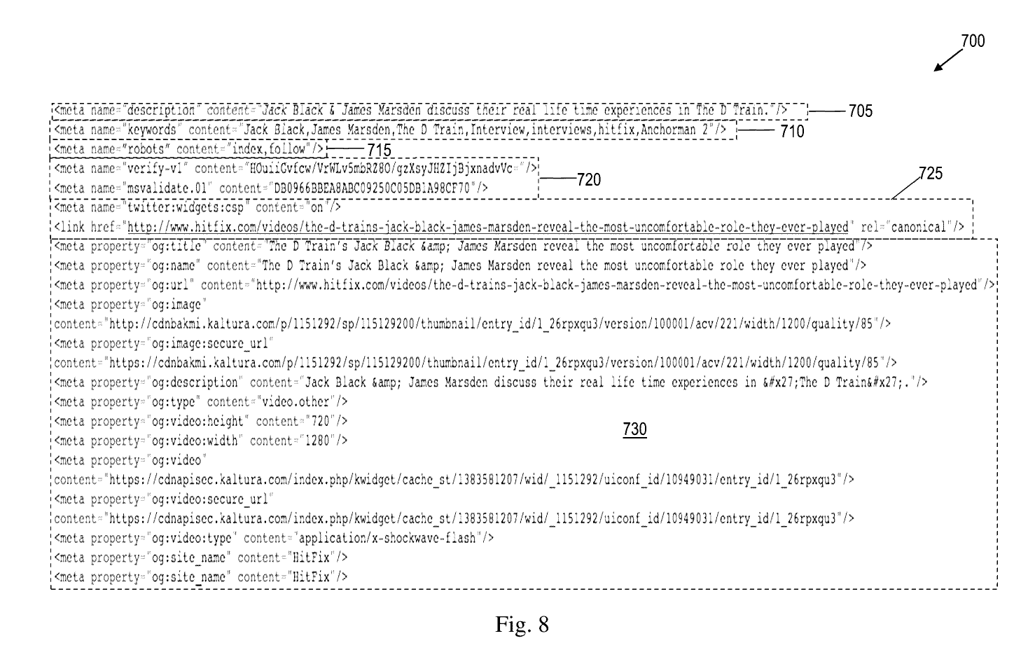

FIG. 8 is an illustration of one embodiment of a portion of web page metadata. Specifically, FIG. 8 is one embodiment of the <head> portion of the web page metadata. As shown in FIG. 8, one embodiment of web page metadata 700 may comprise various metatags and information, including: a description portion 705, keywords portion 710, robots portion 715, verification portion 720, social media portion 725, and open graph markup portion 730. The description portion 705 is generally a brief, plain language description of the web page or document, which is typically used by various search engines to summarize a document in the returned search results. For example, FIG. 8 shows that the description portion 705 may describe the web page as: “Jack Black & James Marsden discuss their real life time experiences in the D Train.” The keywords portion 710 is generally any words or terms used by search engines to index a document in addition to the words in the title and/or document body. For example, the keywords portion 710, as shown in FIG. 7, may be the following: “Jack Black, James Marsden, The D Train, Interview, interviews, hitfix, Anchorman 2”. The robots portion 715 generally controls the behavior of web robots. FIG. 8, for example, shows that the robots portion 715 may instruct the robots to perform indexing of the linked pages and following links on a web page. The verification portion 720 may be used to verify ownership of a website. The social media widget portion 725 may include widget webpage properties for interpretation by social media's widget Javascript® (e.g., Twitter®) before creating a new widget or button. For example, as shown in FIG. 8, the social media widget portion 725 may disable the functionality that triggers content security policy warnings via the “csp=on” function. The open graph markup portion 730 is generally used to show how content is shared in other third party or social media websites such as Facebook®. Some of the meta tags used for the open graph markup portion may include following, as shown in Table 1:

TABLE 1

| | |
|---|---|
| og:title | This is the title of the article. |
| og:url | This is generally the canonical URL for the web page for |
| | identifying a single page for all “likes”, “shares”, |
| | and approvals in social media. |
| og:description | A brief description of the content, usually between 2 |
| | and 4 sentences. This is generally displayed in social |
| | media sites such as Facebook ® |
| og:image | The URL of the image that appears when someone shares |
| | the content to third party sites such as social media |
| | sites. |
| og:type | The type of media of your content. This tag impacts how |
| | your content shows up in News Feed. If you don't |
| | specify a type, the default is website. |
| og:site_name | The name of your website. |

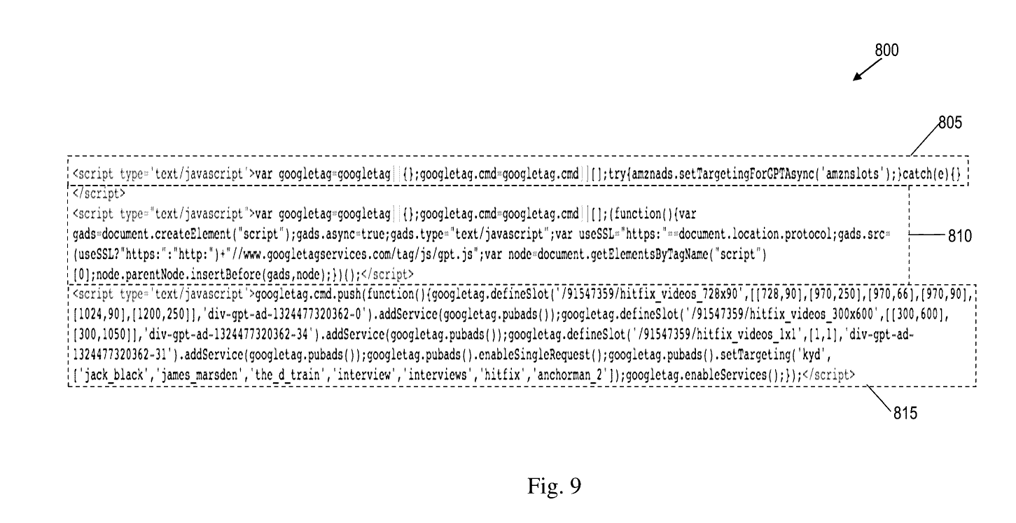

FIG. 9 is an illustration of one embodiment of an ad metadata. As shown in FIG. 9, one embodiment of an ad metadata 800 may comprise various ad metatags and information, including: a callback function portion 805, an ad tagging library portion 810, and the ad configuration portion 815. The callback function portion 805 preferably sets the custom targeting on the advertisement software engine such as DFP. The ad tagging library portion 810 generally helps display ad content on a web page and may be used to load an ad tagging library (e.g., Google® Publisher Tag (GPT)), which can help dynamically build ad requests. The ad tagging library may take key details such as ad unit name, ad size, and custom targeting, builds the request, and displays the ad on web pages. In this embodiment, the ad tagging library portion 810 preferably loads the GPT library from http(s)://www.googletagservices.com/tag/js/gpt.js, which is generally the global namespace that the GPT uses for its application program interface. Once the GPT library has been included on the page, the googletag class may be available for subsequent commands placed on the web page. The ad configuration portion 815 is preferably used to configure the overall ad content behavior for the web page and helps initialize the ad tagging library. In this embodiment, the ad configuration portion 815 may initialize GPT by using the “enableServices” method in the googletag class. The ad configuration portion 815 may also be used to configure the ad unit name, ad size, and ad source.

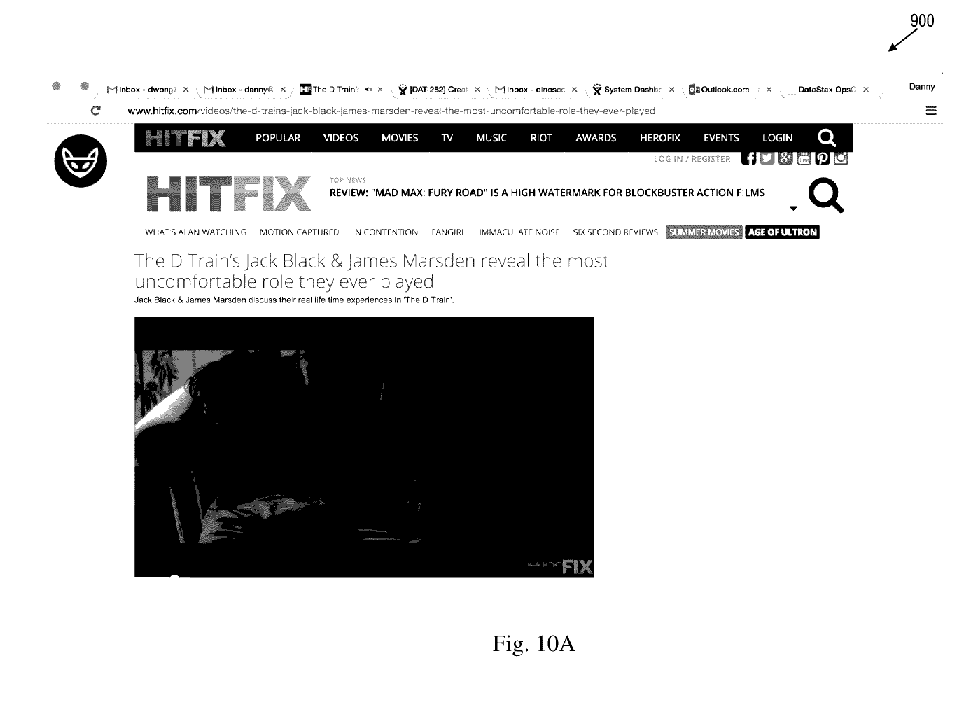

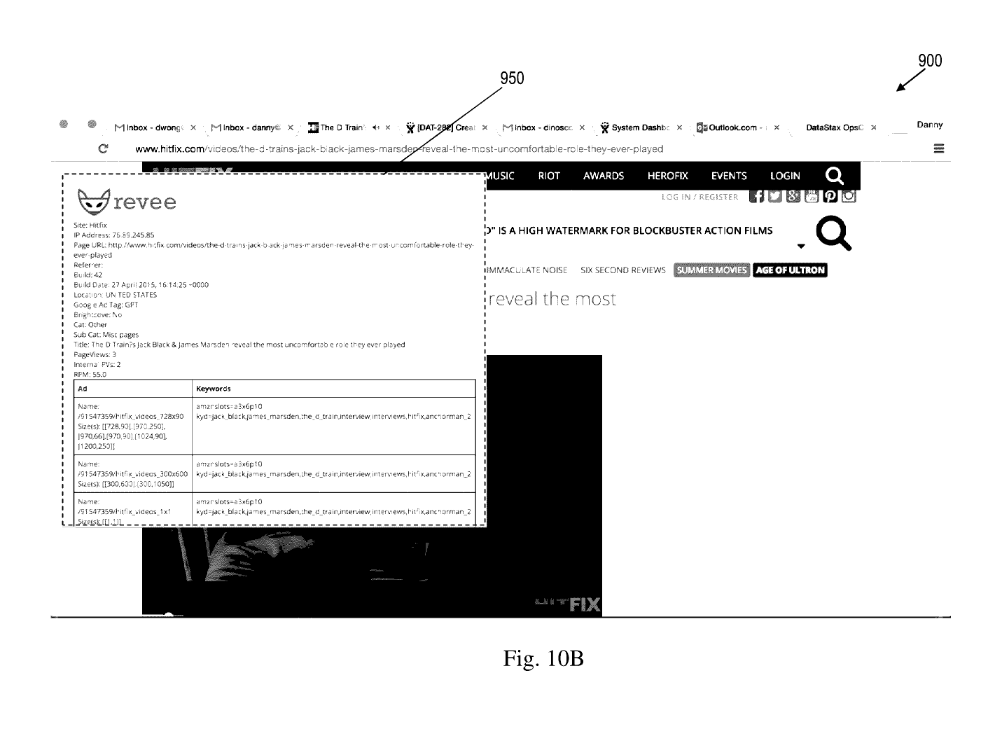

FIG. 10A is a screenshot of one embodiment of a web page based on the page metadata and ad metadata shown in FIGS. 8 and 9, respectively. FIG. 10A shows that the URL (i.e., http://www.hitfix.com/videos/the-d-trains-jack-black-james-marsden-reveal-the-most-uncomfortable-role-they-ever-played), title of the web page (“The D Train's Jack Black & James Marsden reveal the most uncomfortable role they ever played), video, advertisement (i.e., HitFix), and other contents correspond with the data derived from the contents of the page metadata and ad metadata, shown in FIGS. 8 and 9.

FIG. 10B is a screenshot of one embodiment of a web page shown in FIG. 10A and shows how the console provides the user or visitor with data or information relating to the web page and ad, including a revenue value. As shown in FIG. 10B, one embodiment of a web page 900 may comprise a console 950. The console 950 may be a control unit that provides data or information to a user relating to the web page and ad, including a revenue value. In this embodiment, as shown in FIG. 9B, the console 950 may provide website information such as the name of the site (i.e., Hitfix), IP address of the website (i.e., 76.89.245.85), web page URL, build data, location data (e.g., United States), page views, and RPM (i.e., 55.0). The console 950 may also provide additional data and information relating to the ads shown in that web page. An example of ad data and information, as shown in FIG. 9B and provided by the console 950, may be the following:

Name: /91547359/hitfix_videos_728×90

### Sizes: [728,90], [970,250], [970,66], [970,90], [1024,90], [1200, 250]

Keywords: amznslots=a3×6p10
Kyd=jack_black, james_marsden_the_d_train, interview, interviews, hitfix, anchorman_2

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A computer-implemented method for assigning yield and revenue values to web page content in real time, the steps comprising:
providing a script component and an application server;
wherein said script component is configured to run on one or more web pages of a computer system and is configured to analyze an ad metadata associated with one or more ads of said one or more web pages when said script component is running;
wherein said application server is configured to:
analyze one or more events;
determine said one or more ads based on said one or more events; and
determine a revenue data based on said one or more ads;
prompting a user to embed said script component into said one or more web pages;
analyzing said ad metadata when said script component is running;
sending, based at least in part on said ad metadata, said one or more events to said application server;
analyzing said one or more events of said one or more web pages;
determining, based at least in part on said one or more events, said one or more ads that would be displayed on said one or more web pages; and
determining a revenue data based on said one or more ads.

2. The computer-implemented method, according to claim 1, wherein said one or more events comprise an ad name data.

3. The computer-implemented method, according to claim 1, wherein said one or more events comprise an ad size data.

4. The computer-implemented method, according to claim 1, wherein said one or more events comprise an ad keyword data.

5. The computer-implemented method, according to claim 1, wherein said one or more events comprise an ad traffic source data.

6. The computer-implemented method, according to claim 1, further comprising the step of:
filtering one or more ad line items associated with said one or more web pages.

7. The computer-implemented method, according to claim 1, further comprising the step of:
assigning one or more revenue values to one or more web pages based on said revenue data.

8. A computer-implemented method for assigning yield and revenue values to web page content in real time, the steps comprising:
providing a script component and an application server;
wherein said script component is configured to run on one or more web pages of a computer system and is configured to analyze an ad metadata associated with one or more ads of said one or more web pages and a visitor metadata when said script component is running;
wherein said application server is configured to:
analyze one or more events;
determine said one or more ads based on said one or more events; and
determine a revenue data based on said one or more ads;
prompting a user to embed said script component into said one or more web pages;
analyzing said ad metadata and said visitor metadata when said script component is running;
sending, based at least in part on said ad metadata and said visitor metadata, said one or more events to said application server;
analyzing said one or more events of said one or more web pages;
determining, based at least in part on said one or more events, said one or more ads that would be displayed on said one or more web pages; and
determining a revenue data based on said one or more ads.

9. The computer-implemented method, according to claim 8, wherein said one or more events comprise an ad name data.

10. The computer-implemented method, according to claim 8, wherein said one or more events comprise an ad size data.

11. The computer-implemented method, according to claim 8, wherein said one or more events comprise an ad keyword data.

12. The computer-implemented method, according to claim 8, wherein said one or more events comprise an ad traffic source data.

13. The computer-implemented method, according to claim 8, wherein said visitor metadata comprises a location of said visitor.

14. The computer-implemented method, according to claim 8, wherein said visitor metadata comprises a device type of said visitor.

15. The computer-implemented method, according to claim 8, further comprising the step of:
filtering one or more ad line items associated with said one or more web pages.

16. The computer-implemented method, according to claim 8, further comprising the step of:
assigning one or more revenue values to one or more web pages based on said revenue data.

17. A system for assigning yield and revenue values to web page content in real time, comprising:
one or more non-transitory computer readable storage mediums;
a script component, said script component stored in said one or more non-transitory computer-readable storage mediums; and
an application server, said application server stored in said one or more non-transitory computer-readable storage mediums;
wherein said script component is configured to run on one or more web pages of a computer system and is configured to:
analyze an ad metadata associated with one or more ads of said one or more web pages and a visitor metadata when said script component is running; and
send, based at least in part on said ad metadata and said visitor metadata, one or more events to said application server;
wherein said application server is configured to:
analyze one or more events;
determine said one or more ads based on said one or more events; and
determine a revenue data based on said one or more ads; and
assign one or more revenue values to one or more web pages based on said revenue data.

18. The system, according to claim 17, wherein said one or more events comprise an ad name data, an ad size data, and an ad keyword data.

19. The system, according to claim 17, wherein said one or more events comprise an ad traffic source data.

20. The system, according to claim 17, wherein said visitor metadata comprises a location of said visitor and a device type of said visitor.
